(19) United States
(12) Patent Application Publication
(10) Pub. No.: US 2011/0004532 A1
(43) Pub. Date: Jan. 6, 2011

(54) Electronic consumption system for a mobile communication device

(75) Inventor: Ming-Shun YU, Longtan Township (TW)

Correspondence Address: Muncy, Geissler, Olds & Lowe, PLLC, 4000 Legato Road, Suite 310, FAIRFAX, VA, 22033, US

(73) Assignee: A-Men Technology Corporation

(21) Appl. No.: 11/987,121

(22) Filed: Nov. 27, 2007

(51) Int. Cl. G06Q 30/00

(52) U.S. Cl. 705/26.41

(57) ABSTRACT

An electronic consumption system for a mobile communication device receives a transaction message transmitted by a user's mobile communication device, and transmits consumption information to a financial institute port and a vendor port, allowing the vendor port to provide a business activity corresponding to the transaction message, and the financial institute port to conduct debiting to the user and appropriation to the vendor port, corresponding to the transaction message. Therefore, the user can conduct a business activity, like consuming and purchasing, through the mobile communication device at any time, and can be aware of business messages provided by different vendor ports. In addition, an alliance among different industries at the vendor port, and an interaction between the financial institutes can be facilitated.

### BACKGROUND OF THE INVENTION

a) Field of the Invention

The present invention relates to an electronic consumption system, and more particularly to an electronic consumption system applied to a mobile communication device, by which value saving and consumption can be made at any time.

b) Description of the Prior Art

It is known that for consumption in a physical store conventionally, a consumer should go to the store personally to proceed with a business activity, such as shopping, purchasing a ticket, etc. However, some business activities should be reserved with the stores by phones, such as boarding, dining, etc. Therefore, there still exists a lot of inconvenience to the consumers.

As the advancement of technology, and through the continuous progress of network and wired TV (television), the purchasing method is also changing continuously. For example, for most convenient online purchasing and TV purchasing in a present day, after watching a shopping channel from a wired TV, and placing an order through a phone or through browsing a shopping site on internet, a consumer can wait at home for delivery by a vendor. Therefore, the conventional purchasing method requiring constant moving has been evolved to the purchasing at a fixed point, and at any time.

Although the online purchasing or the TV purchasing allows the consumer to purchase or consume at home, when the consumer is out (at work, in window shopping, or in traveling), he or she will still expect to purchase in an unphysical store immediately, or to consume and purchase at a physical store, through an advertisement medium (a sign, a post, a DM—Direct Mail, a broadcast, a news-brief, etc.). Accordingly, how to provide a method that allows the consumer to access a message of purchasing and consumption at any time, and to proceed with purchasing and shopping at any time and at any place, is an issue to be solved by the present inventor and related industries.

### SUMMARY OF THE INVENTION

The primary object of the present invention is to provide an electronic consumption system. The electronic consumption system is connected with a mobile communication device through a mobile communication network, and is connected in advance with a financial institute port and a vendor port. The mobile communication device is provided with a user interface which can transmit a transaction message to the electronic consumption system, and a communication module of the electronic consumption system will transmit the received transaction message to a message module which will transmit the transaction message to a transaction module. The transaction module will then transmit the transaction message to the corresponding vendor port and billing module. Accordingly, the vendor port can provide the user with a corresponding business activity, and proceed with collection at the financial institute port through the billing module of the electronic consumption system; whereas, the financial institute port can debit to a user account through the billing module of the electronic consumption system, and appropriate to the vendor port.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a block diagram of the present invention.

FIG. 2 shows a first flow diagram of the present invention.

FIG. 3 shows a second flow diagram of the present invention.

FIG. 4 shows a third flow diagram of the present invention.

FIG. 5 shows another block diagram of the present invention.

FIG. 6 shows a fourth flow diagram of the present invention.

FIG. 7 shows a fifth flow diagram of the present invention.

### DETAILED DESCRIPTION OF THE PREFERRED EMBODIMENTS

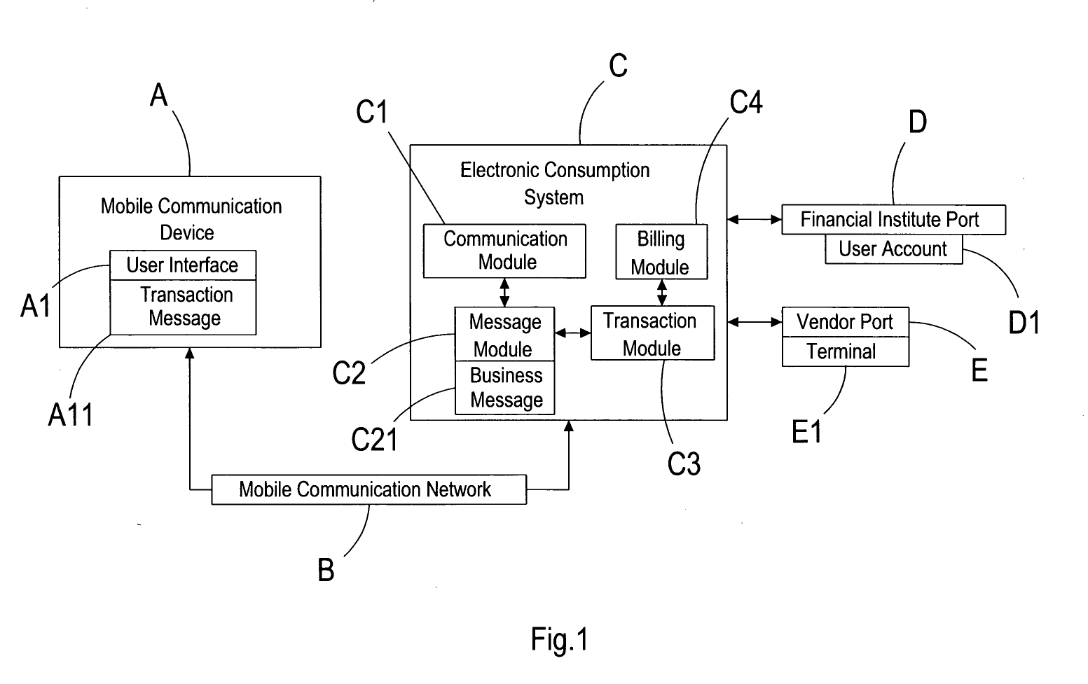

Referring to FIG. 1, it shows a block diagram of the present invention which is constituted by a mobile communication device A and an electronic consumption system C, wherein the electronic consumption system C is connected with the mobile communication device A through a mobile communication network B, and is connected in advance with a financial institute port D and a vendor port E; whereas, the financial institute port D is provided with a user account D1 to proceed with value saving and debiting, and the vendor port E is provided with a terminal E1.

The mobile communication device A is provided with a user interface A1 which stores a plurality of transaction messages A11. Each transaction message A11 records a financial data of an amount of money, user's information, and information of a vendor who provides a business activity, for each transaction. The mobile communication device A can be a mobile phone, a PDA (Personal Digital Assistant), or a notebook computer, and can transmit the transaction message A11 through SMS (Short Message Service), MMS (Multimedia Messaging Service), and EMS (Electronic Message Service).

The electronic consumption system C is provided with a communication module C1, a message module C2, a transaction module C3, and a billing module C4, wherein the communication module C1 is connected with the mobile communication device A, and transmits the transaction message A11 and a business message C21; the message module C2 is connected with the communication module C1, is provided with the plural business messages C21, and can receive the transaction message A11 which is transmitted by the communication module C1; the transaction module C3 is connected with the message module C2, can transmit the transaction message A11 to the vendor port E, and can transmit the business message C21 provided by the vendor port E to the message module C2; whereas, the billing module C4 is connected with the transaction module C3, and can transmit the transaction message A11 to the financial institute port D to process a bill.

Moreover, the aforementioned mobile communication network B can be one of GSM (Global System for Mobile Communications), CDMA (Code Division Multiple Access), PHS (Personal Handy-phone System), GPRS (General Packet Radio Service), WiFi (Wireless Fidelity), or a mobile communication system of a third or higher generation. The user interface A1 can be a hardware which is attached to a SIM (Subscriber Identity Module) card of a mobile communication device in an integrated-circuit style, a firmware which can be burnt into a SIM card or an integrated circuit in the mobile communication device, or any software which can be implanted into an operating system of the mobile communication device.

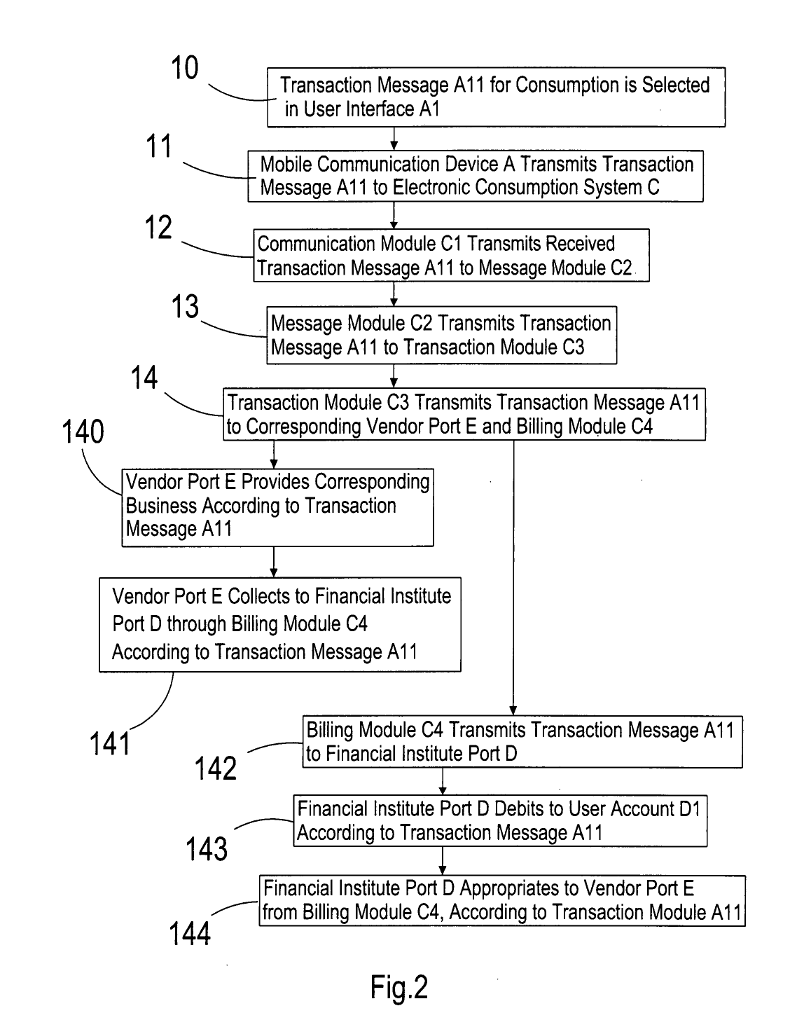

Referring to FIG. 1 and FIG. 2, an electronic consumption is proceeding according to following steps:

(10) The transaction message A11 for consumption is selected in the user interface A1;
(11) The mobile communication device A transmits the transaction message A11 to the electronic consumption system C;
(12) The communication module C1 transmits the transaction message A11 received to the message module C2;
(13) The message module C2 transmits the transaction message A11 to the transaction module C3;
(14) The transaction module C3 transmits the transaction message A11 to the corresponding vendor port E and billing module C4;
(140) According to the transaction message A11, the vendor port E provides the corresponding business activity;
(141) According to the transaction message A11, the vendor port E collects to the financial institute port D through the billing module C4;
(142) The billing module C4 transmits the transaction message A11 to the financial institute port D;
(143) According to the transaction message A11, the financial institute port D proceeds with a debiting to the user account D1;
(144) According to the transaction message A11, the financial institute port D proceeds with an appropriation to the vendor port E, from the billing module C4.

Upon conducting the aforementioned steps, the user can manipulate and browse the user interface A1 in the mobile communication device A, and select the transaction message A11 for consumption in the user interface A1. The transaction message A11, after being selected, can be transmitted to the electronic consumption system C through the mobile communication network B by SMS, MMS, or EMS. The communication module C1 of the electronic consumption system C will transmit the received transaction message A11 to the message module C2, which will recover the financial data of the amount of money, the user's information and the vendor's information in the transaction message A11. Next, the transaction message A11 is transmitted to the transaction module C3 which will transmit the transaction message A11 to the corresponding vendor port E and the billing module C4, depending on the financial data of the amount of money, the user's information and the vendor's information in the transaction message A11. At this time, the vendor port E will provide the user with the corresponding business activity depending on the user's information, and conduct the collection to the financial institute port D depending on the financial data, through the billing module C4. The financial institute port D will conduct the debiting to the user account D1 depending on the user's information and the financial data, and conduct the appropriation to the vendor port E depending on the vendor's information and the financial data, through the billing module C4.

The aforementioned transaction message A11 is further described below:
1. If the transaction message A11 is a movie ticket, a ticket of an exhibition, a train ticket, an airline tickets, or a ticket of any kind of show, then the user can. browse the ticket price, time and place of the business activity corresponding to the ticket, on the user interface A1 first. When the user has selected the time, place, or an entrance position for attendance, he or she can transmit the transaction message A11 to the electronic consumption system C; whereas, the electronic consumption system C will process according to the steps disclosed in FIG. 1 and FIG. 2. After accomplishing the business transaction of the transaction message A11, the consumer can go to the place where the business activity happens, to take the ticket and enter, according to the selected time and place.
2. If the transaction message A11 is a purchase of clothes, books, daily necessaries, cosmetics, or food, then the user can browse prices, content description, or discount information on the user interface A1 first. When the articles for purchasing have been selected, and a delivery place or a place for picking up has been assigned, the transaction message A11 can be transmitted to the electronic consumption system C which will process through the steps disclosed in FIG. 1 and FIG. 2. After accomplishing the business transaction of the transaction message A11 by the consumer, the vendor port E will be informed with what articles have been purchased by the consumer through the transaction message A11, and at a same time, will proceed with the delivery of the articles according to the delivery place or the place for picking up as designated by the consumer.
3. If the transaction message A11 is a business service like maintenance of a car, a registration in a hospital, or a church service, then the user can browse a location, service items, and an appointment time for each business service on the user interface A1 first. When the business service for registration has been selected, the user can transmit the transaction message A11 to the electronic consumption system C which will process through the steps disclosed in FIG. 1 and FIG. 2. After accomplishing the business transaction of the transaction message A11 by the consumer, he or she can go to the place of business service to conduct the selected business service, according to the selected time and place.

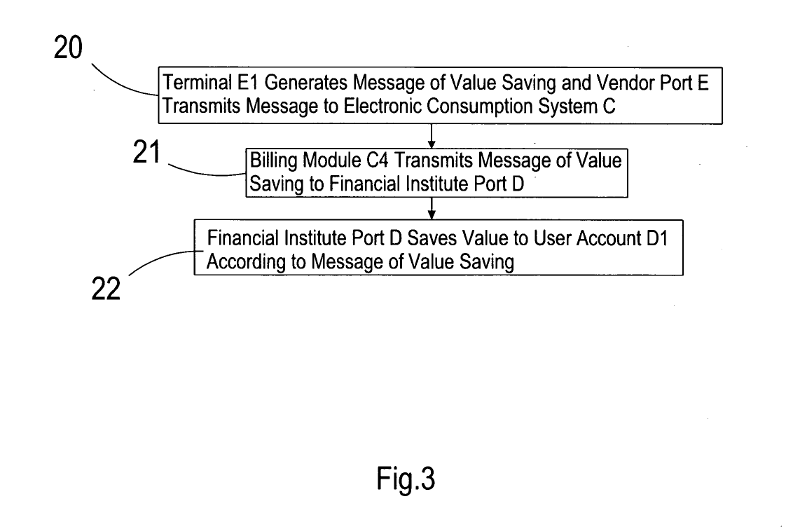

Referring to FIG. 1 and FIG. 3, following steps are conducted to save a value to the user account D1:

(20) The terminal E1 generates a message of value saving and the vendor port E transmits that message to the electronic consumption system C;
(21) The billing module C4 transmits the message of value saving to the financial institute port D;
(22) The financial institute port D saves the value to the user account D1 according to the message of value saving.

Upon conducting the aforementioned steps, the user can save a value through the terminal E1 of the vendor port E, and a message of value saving will be generated by the terminal E1 after saving the value, and be transmitted to the electronic consumption system C. After the billing module C4 of the electronic consumption system C has received the message of value saving, the billing module C4 will transmit the message of value saving to the financial institute port D which will save the value to the user account D1 according to the message of value saving.

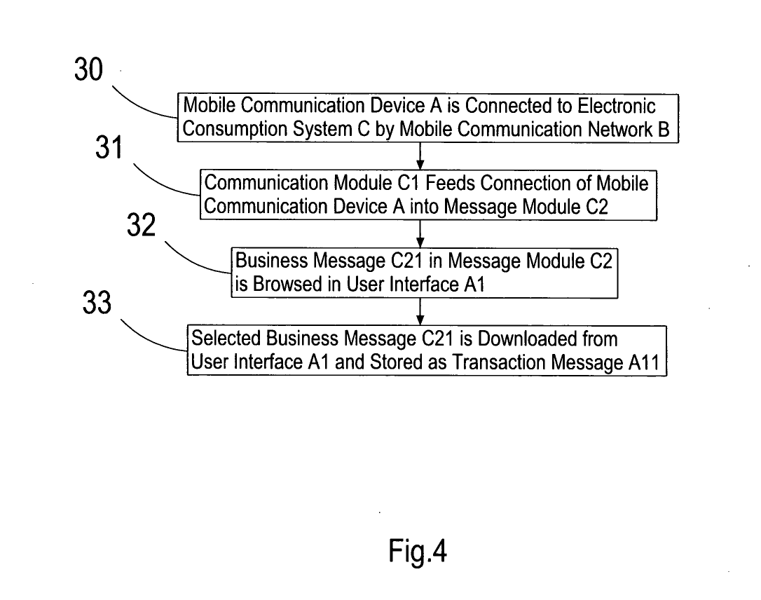

Referring to FIG. 1 and FIG. 4, following steps are conducted to receive the business message C21:

(30) The mobile communication device A is connected to the electronic consumption system C through the mobile communication network B;
(31) The communication module C1 feeds the connection of the mobile communication device A into the message module C2;
(32) The business message C21 in the message module C2 is browsed in the user interface A1;
(33) The business message C21 to be selected is downloaded from the user interface A1, and is stored as the transaction message A11.

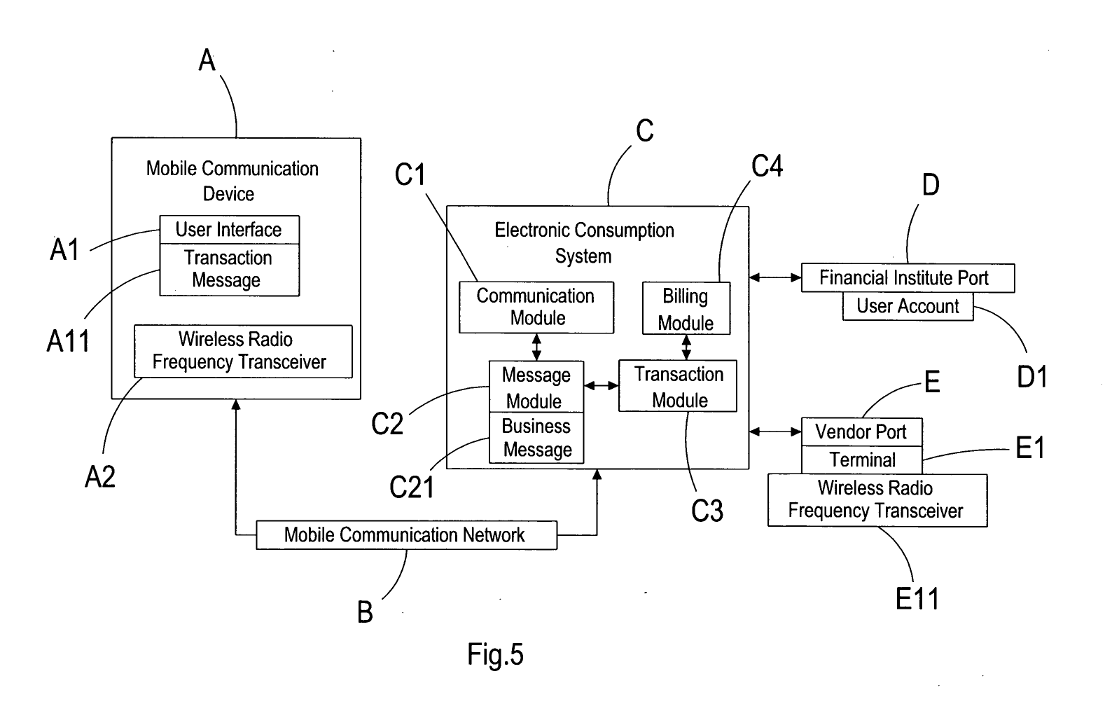

Referring to FIG. 5, it shows another block diagram of the present invention, wherein the mobile communication device A is further provided with a wireless radio frequency transceiver A2, and the terminal E1 is further provided with a wireless radio frequency transceiver E11, such that the mobile communication device A and the terminal E1 can transmit the transaction message A11 or receive the business message C21 by wireless radio frequency signals.

Furthermore, after the user has processed the transaction message A11 through the steps disclosed in FIG. 1 and FIG. 2, induction can be proceeding by the wireless radio frequency transceiver A2 of the mobile communication device A, and the wireless radio frequency transceiver E11 of the terminal E1, and then:

1. If the transaction message A11 is a movie ticket, a ticket of an exhibition, a train ticket, an airline ticket, or a ticket of any kind of show, then after processing the transaction message A11 through the steps disclosed in FIG. 1 and FIG. 2, the user can go to the place where the business activity happens according to the selected time and place, and the induction can be proceeding by the wireless radio frequency transceiver A2 of the mobile communication device A, and the wireless radio frequency transceiver E11 of the terminal E1; and when the terminal E1 inducts that the mobile communication device A has accomplished the transaction message A11, the user can directly enter into a movie theater, an exhibition place, a train station, an airport, or any kind of show place, without requiring an action of taking the ticket;
2. If the transaction message A11 is a business service like maintenance of a car, a registration in a hospital, or a church service, then after processing the transaction message A11 through the steps disclosed in FIG. 1 and FIG. 2, the user can go to the place of business service according to the selected time and place, and the induction can be proceeding by the wireless radio frequency transceiver A2 of the mobile communication device A, and the wireless radio frequency transceiver E11 of the terminal E1; and when the terminal E1 inducts that the mobile communication device A has accomplished the transaction message A11, the user can directly enter into the place of business service to conduct the reserved business service.

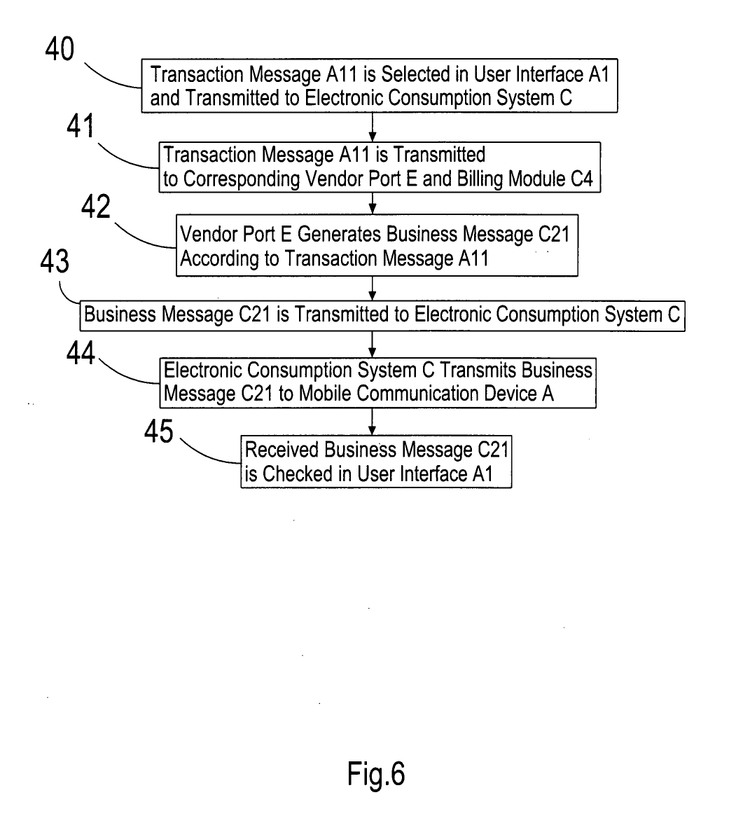

Referring to FIG. 1 and FIG. 6, following steps are conducted to download a new subscription number:

(40) The transaction message A11 is selected in the user interface A1, and is transmitted to the electronic consumption system C;
(41) The transaction message A11 is transmitted to the corresponding vendor port E and the billing module C4;
(42) The vendor port E generates the business message C21 according to the transaction message A11;
(43) The business message C21 is transmitted to the electronic consumption system C;
(44) The electronic consumption system C transmits the business message C21 to the mobile communication device A;
(45) The received business message C21 is checked in the user interface A1.

Upon conducting the aforementioned steps, the user will select the transaction message A11 for consumption in the mobile communication device A, and at this time, the selected transaction message A11 is a transaction for downloading a subscription number of a mobile communication, and is then transmitted to the electronic consumption system C through the mobile communication network B, wherein the transaction message A11 is transmitted to the message module C2 through the communication module C1, the message module C2 recovers the financial data, the user's information and the vendor's information in the transaction message A11, and then transmits the recovered transaction message A11 to the transaction module C3 which transmits the transaction message A11 to the corresponding vendor port E and the billing module C4, according to the financial data, the user's information and the vendor's information in the transaction message A11. At this time, the vendor port E will generate the business message C21 according to the user's information, and transmit the business message C21 to the electronic consumption system C which will transmit the business message C21 to the mobile communication device A by using the communication module C1. In addition, the received business message C21 that can be browsed in the user interface A1 is the newly downloaded subscription number of mobile communication, which will be burnt into the SIM card through the user interface A1. Accordingly, it will not require a salesroom to add or exchange the subscription number. of the mobile communication device A. As the following financial part can be referred to in the description of the aforementioned process, it will not be addressed further.

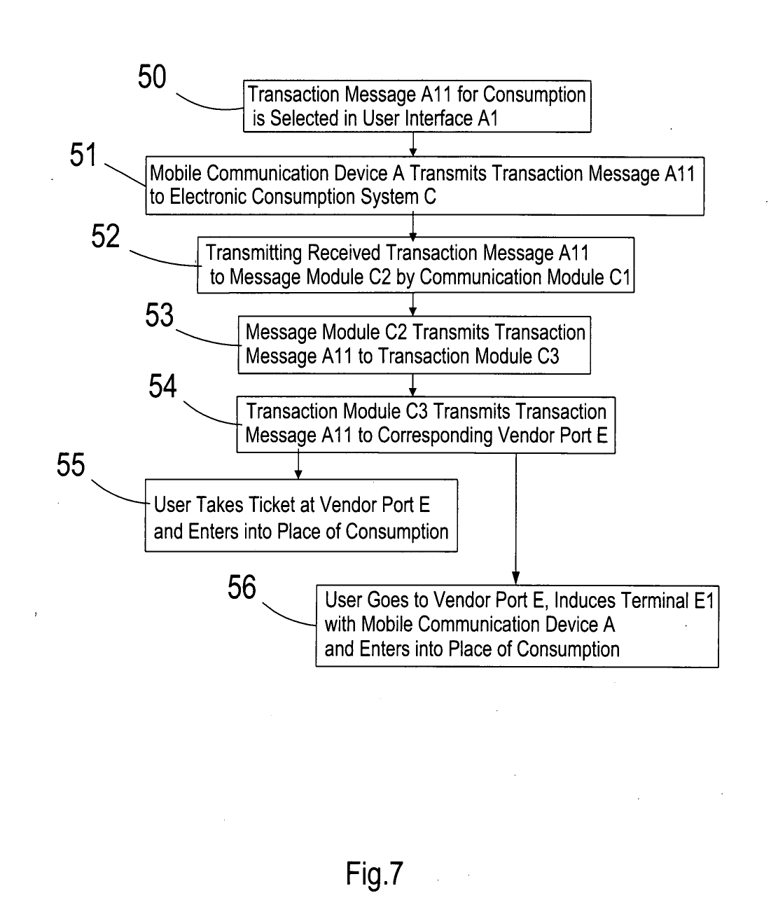

Referring to FIG. 1, FIG. 5, and FIG. 7, when the transaction message A11 is a movie ticket, a ticket of an exhibition, a train ticket, an airline tickets, or a ticket of any kind of show, following steps are conducted:

(50) The transaction message A11 for consumption is selected in the user interface A1;
(51) The mobile communication device A transmits the transaction message A11 to the electronic consumption system C;
(52) The communication module C1 transmits the received transaction message A11 to the message module C2;
(53) The message module C2 transmits the transaction message A11 to the transaction module C3;
(54) The transaction module C3 transmits the transaction message A11 to the corresponding vendor port E;
(55) The user takes the ticket at the vendor port E and enters into the place of consumption;
(56) The user goes to the vendor port E and uses the mobile communication device A to induct the terminal E1, and then enters into the place of consumption.

Upon conducting the aforementioned steps, the user browses a ticket price, time and place of the business activity corresponding to the ticket, on the user interface A1 first. When the user has selected the time, place, or an entrance position for attendance, he or she transmits the transaction message A11 to the electronic consumption system C; whereas, the electronic consumption system C will transmit the transaction message A11 to the corresponding vendor port E. At this time, the vendor port E will provide the user with the corresponding business activity, according to the user's information. When the consumer goes to the vendor port E, he or she can select to take the ticket to enter into the place where the business activity happens, or to directly enter into the place of business activity without taking the ticket, by inducting the wireless radio frequency transceiver E11 of the terminal E1 with the wireless radio frequency transceiver A2 of the mobile communication device A, to allow the terminal E1 to induct that the mobile communication device A has accomplished the transaction message A11.

Moreover, when the transaction message A11 is the business service like maintenance of a car, a registration in a hospital, or a church service, then after processing the transaction message A11 through the aforementioned steps first, the user can go to the place of business service for conducting the business service, according to the selected time and place, or can select to induct the wireless radio frequency transceiver E11 of the terminal E1 with the wireless radio frequency transceiver A2 of the mobile communication device A, allowing the terminal E1 to induct that the mobile communication device A has accomplished the transaction message A11. Then, the user can directly enter into the place of business service to conduct the reserved business service.

The technological factors of the present invention for improving the prior art are:

1. As the electronic consumption system C provides for joining of various vendor ports E, each vendor port E can exchange member information, so as to achieve an effect of establishing an alliance between different industries. In a mean time, the user can download the business messages C21 provided by different vendor ports E and obtain more real-time consumption information, in the electronic consumption system C.
2. The electronic consumer system C allows different vendor ports E to join in, so as to provide the consumers with different types of business activities, such as booking movie tickets, reserving for maintenance of cars, donating to churches, paying hospital registration fees or all kinds of bills, etc., thereby attracting more consumers to connect to the electronic consumption system C with the mobile communication device A, to reach higher output value and economic value.
3. The user interface A1 can be added into the mobile communication device A in a form of hardware, software, or firmware; therefore, the user can operate the user interface A1 in the original mobile communication device A without exchanging a SIM card of the mobile communication device A or replacing the mobile communication device A and its operating system, thereby being provided with good convenience and facilitating the vendor port E to conduct promotion and marketing of business activities.
4. The electronic consumption system C can provide the user with the service of downloading the subscription number on-line, through the mobile communication device A. Therefore, the user can download the subscription number of mobile communication, and the subscription number can be burnt into the mobile communication device A through the user interface A1, after accomplishing the download operation. Accordingly, when the user is to replace or add the subscription number, he or she can freely proceed with the replacement or addition, without needing to go to a communication industry, thereby saving time of the user and being provided with convenience that the subscription number can be replaced or added at any time and at any place.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. An electronic consumption system for a mobile communication device, comprising a mobile communication device and an electronic consumption system, wherein the electronic consumption system is connected with the mobile communication device by a mobile communication network, and is connected in advance with a financial institute port and a vendor port; the mobile communication device being provided with a user interface which stores a plurality of transaction messages; the electronic consumption system being provided with a communication module, a message module, a billing module and a transaction module, with the communication module being connected with the mobile communication device, and transmitting the transaction messages and business messages; the message module being connected with the communication module, being provided with the plural business messages, and receiving the transaction messages transmitted by the communication module; the transaction module being connected with message module, transmitting the transaction messages to the vendor port, and transmitting the business messages provided by the vendor port to the message module; the billing module being connected with the transaction module, and transmitting the transaction messages to the financial institute port to process bills.

2. The electronic consumption system for a mobile communication device, according to claim 1, wherein the financial institute port is pre-built with a user account for saving a value and debiting.

3. The electronic consumption system for a mobile communication device, according to claim 1, wherein the vendor port is pre-built with a terminal for transmitting a message of value saving to the electronic consumption system.

4. The electronic consumption system for a mobile communication device, according to claim 1, wherein upon conducting an electronic consumption, following steps are taken:
a transaction message being selected for consumption in the user interface;
the mobile communication device transmitting the transaction message to the electronic consumption system;
the communication module. transmitting the transaction message to the message module;
the message module transmitting the transaction message to the transaction module;
the transaction module transmitting the transaction message to the corresponding vendor port and billing module.

5. The electronic consumption system for a mobile communication device, according to claim 4, wherein upon transmitting the transaction message to the corresponding vendor port by the transaction module, following steps are taken:
the vendor port providing a corresponding business activity according to the transaction message;
the vendor port collecting to the financial institute port through the billing module, according to the transaction message.

6. The electronic consumption system for a mobile communication device, according to claim 4, wherein upon transmitting the transaction message to the billing module by the transaction module, following steps are taken:
the billing module transmitting the transaction message to the financial institute port;
the financial institute port debiting to the user account according to the transaction message;
the financial institute port appropriating to the vendor port from the billing module, according to the transaction message.

7. The electronic consumption system for a mobile communication device, according to claim 1, wherein the transaction message includes a financial data, user's information, and vendor's information; the financial data recording an amount of money for each transaction; the user's information recording the user for each transaction; the vendor's information recording the provider of business activity and information of transacted products, for each transaction.

8. The electronic consumption system for a mobile communication device, according to claim 1, wherein the financial institute port collects to the user account according to the user's information and the financial data, and appropriates to the vendor port according to the vendor's information and the financial data; the vendor port providing the user with the corresponding business activity according to the user's information, and collecting to the financial institute port according to the financial data.

9. The electronic consumption system for a mobile communication device, according to Claim 3, wherein upon saving a value to the user account, following steps are taken:
the terminal generating a message of value saving and the vendor port transmitting that message to the electronic consumption system;
the billing module transmitting the message of value saving to the financial institute port;
the financial institute port saving the value to the user account according to the message of value saving.

10. The electronic consumption system for a mobile communication device, according to claim 1, wherein upon receiving the business message by the mobile communication device, following steps are taken:
the mobile communication device being connected to the electronic consumption system by the mobile communication network;
the communication module feeding the connection of the mobile communication device into the message module;
the business message in the message module being browsed in the user interface;
the selected business message being downloaded from the user interface and being stored as the transaction message.

11. The electronic consumption system for a mobile communication device, according to claim 3, wherein the terminal and the mobile communication device are further provided with wireless radio frequency transceivers, and the transaction message is transmitted or the business message is received, by wireless radio frequency signals.

12. The electronic consumption system for a mobile communication device, according to claim 1, wherein the mobile communication system transmits the transaction message through SMS (Short Message Service), MMS (Multimedia Messaging Service), or EMS (Electronic Message Service).

13. The electronic consumption system for a mobile communication device, according to claim 1, wherein the user interface is a hardware which is attached to a SIM (Subscriber Identity Module) card of the mobile communication device in a form of integrated circuit, a firmware which is burnt into the SIM card and the integrated circuit of the mobile communication device, or a software which is implanted into an operating system of the mobile communication device.

14. The electronic consumption system for a mobile communication device, according to claim 1, wherein the business message is a subscription number of mobile communication which is downloaded from the user interface of the mobile communication device, and is then burnt into the mobile communication device.
